(19) United States
(12) Patent Application Publication
(10) Pub. No.: US 2017/0122794 A1
(43) Pub. Date: May 4, 2017

(54) COMBINATION MEASURING DEVICE FOR MEASURING THE WEIGHT AND AT LEAST ONE FURTHER BODY PARAMETER OF A SUBJECT

(71) Applicant: seca ag, Reinbach BL (CH)

(72) Inventor: Jan Schmidt, Bargteheide (DE)

(73) Assignee: seca ag, Reinbach BL (CH)

(21) Appl. No.: 15/340,592

(22) Filed: Nov. 1, 2016

(30) Foreign Application Priority Data
Nov. 3, 2015 (DE) 102015118770.1

(51) Int. Cl. G01G 19/414; G01G 19/50

(52) U.S. Cl. CPC G01G 19/414; G01G 19/50

(57) ABSTRACT

A combination measuring device for measuring the weight and a further body parameter of a subject includes a weighing scale, a measuring apparatus for the further body parameter, and a data acquisition and processing unit to control the measuring process of the scale and measuring apparatus. The device acquires from the scale measuring signals representing a weight as a function of time over a measuring period, processes the signals, and outputs measurement results. The data acquisition and processing unit determines a weight measuring result from the measuring signals of the scale; monitors over the measuring period a deviation of the measuring signals from the weight measuring result; and, in case the deviation exceeds a predetermined first threshold value, generates a suspicion message indicative of possible movement of the subject. The suspicion message is used in an examination of the reliability of the measuring result for the further body parameter.

### CROSS-REFERENCE TO RELATED APPLICATION

The present application claims priority from German Patent Application No. 102015118770.1, filed Nov. 3, 2015, and entitled COMBINATION MEASURING DEVICE FOR MEASURING THE WEIGHT AND AT LEAST ONE FURTHER BODY PARAMETER OF A SUBJECT, the entire disclosure of each of which is hereby incorporated by reference herein.

### BACKGROUND OF THE INVENTION

1. Field of the Invention

The invention relates to a combination measuring device for measuring the weight and at least one further body parameter of a subject, which combination measuring device comprises a weighing scale having a platform that acts on at least one load cell, a measuring apparatus for measuring a further body parameter, and a data acquisition and processing unit which is adapted to control the measuring process of the scale and of the measuring apparatus and to acquire measuring signals of the scale representative for a weight bearing on the platform over a measuring period as a function of time, to acquire measuring signals of the measuring apparatus over the measuring period, to process the measuring signals and to output measurement results.

2. Discussion of the Prior Art

There are a number of combination measuring devices that comprise, in addition to a weighing scale, a measuring apparatus for measuring one or more further body parameters of a subject. Typical examples are devices for determining body composition parameters (Body Composition Analyzers) which comprise a weighing scale and a bioelectrical impedance measuring apparatus which allows to measure the impedance of the body and of individual body segments of a human being. The conductivity of the human body depends sensitively on the water content. Since fat-free portions of the body, such as muscles and body fluids, contain a large part of the water of the body, whereas fat due to its hydrophobic properties contains a very low amount of water, the determination of the conductivity of the body (or conversely of the resistance or impedance) allows to draw conclusions on the relative amount of fat. By simultaneously measuring the weight of the subject this allows to determine the fat mass and the fat-free mass of the body of the subject as well as further body composition parameters such as water mass etc.

An exemplary device of this kind which is adapted for the determination of body composition parameters by bioimpedance analysis is described in DE 10 2010 023 122 A1. Such a combination measuring device for the determination of body composition parameters is shown schematically in FIG. 2. The device has a scale platform supported above the floor, which platform is acting on load cells disposed underneath which allow to determine the weight force acting on platform 1. On the platform there are four foot electrodes 2, wherein the subject steps with each foot on two of the electrodes. Furthermore, four hand electrodes 6 are provided on a hand rail, which hand electrodes have to be grasped by the person to be examined with the hands such that each hand is in contact with two electrodes. An alternating current is then applied through two electrodes in contact with different limbs, and at two other electrodes likewise in contact with two different limbs, the voltage is measured. By transitioning to other pairs of current applying electrodes and voltage measuring electrodes different measuring programs can be executed successively and various body segments can be examined with respect to the impedance. The weighing scale and the electrodes are connected via lines to a data acquisition and processing unit 100 which analyses the measuring signals and outputs measuring results.

With such a combination measuring device including a scale and a measuring apparatus for bioimpedance measurements it is important that the subject does not move during execution of the measuring programs for bioimpedance measurement because movements may falsify the impedance measurements.

In FIG. 1 a further combination measuring device is shown schematically. This device comprises, in addition to a weighing scale, an apparatus for measuring the body length. The weighing scale has a platform 1, wherein four underlying load cells WZ1, WZ2, WZ3, and WZ4 are shown schematically. The measuring apparatus for measuring the body length includes a vertical support, at the upper end of which a cross beam is attached. In the cross beam an ultrasonic transducer is arranged at the end of the cross beam remote from the vertical support. The ultrasonic transducer is arranged such that upon excitation radiated ultrasonic waves are directed onto the top of the head of a subject standing on the platform of the scale. The weighing scale and the ultrasonic transducer are connected via lines to a data acquisition and processing unit 100 which analyses the measurement signals. The data acquisition and processing unit 100 is adapted to perform, by utilizing the ultrasonic transducer, a time-of-flight measurement of the ultrasonic waves reflected on the top of the head of the subject. From the time-of-flight the distance to the top of the head is deduced and from this, taking into account the known vertical position of the cross beam, the body length of the subject is deduced and output by the data acquisition and processing unit 100 in addition to the measuring result of the scale. Also for such a combination measuring device it is important that the subject does not move during the measuring period in which the body length is measured, to obtain an accurate and reliable measurement of the body length.

There are a number of other combination measuring devices that comprise, besides a scale, a further measuring apparatus. A further measuring apparatus in combination with a scale may for example be a blood pressure measurement device. Still another measuring apparatus which can be utilized in combination with a scale is a device for an optical body scan to determine the surface of the body of a subject. Such a device for an optical body scan may for example be a laser scanner, a stereo camera system or a time-of-flight (TOF) camera. In a combination measuring device a weighing scale may also be combined with several measuring apparatuses for measuring different other body composition parameters.

For almost all of such combination measuring devices the measuring values of the further body parameter or body parameters are subject to measurement errors if a patient moves during the measuring period which is needed to acquire the data for the determination of the further body parameter. A check for movement of a subject is performed, if at all, only indirectly and therefore not in a reliable manner. For example, unstable measuring values for the further body parameter or parameters outside of a valid range may indicate a faulty measurement. However, besides movements of the subject there are many other causes for potential errors so that, if an message indicating a faulty measurement is output, the subject gets no feedback regarding the cause of the error.

### SUMMARY

It is an object of the present invention to configure a combination measuring device including a scale and a measuring apparatus for measuring a further body parameter in such a manner that errors in the measurement result of the further measuring apparatus which are caused by movements of the subject during the measurement are easily detectable.

To achieve this object a combination measuring device for measuring a weight and a further body parameter of a subject is provided. The combination measuring device comprises a weighing scale including a platform which acts on at least one load cell, a measuring apparatus for measuring the further body parameter, and a data acquisition and processing unit which is adapted to control a measuring process of the weighing scale and of the measuring apparatus. The data acquisition and processing unit is arranged to acquire from the weighing scale measuring signals representing a weight weighing on the platform as a function of time over a measuring period, to process said measuring signals, and to output measurement results. The data acquisition and processing unit is arranged to determine a weight measuring result from the measuring signals of the weighing scale in advance or at the beginning of the measuring period, and to monitor over the measuring period a deviation of the measuring signals of the weighing scale from the weight measuring result and, in case the deviation exceeds a predetermined first threshold value, to generate a movement suspicion message indicative of a possible movement of the subject. The movement suspicion message is to be used in an examination of the reliability of the measuring result for the further body parameter.

According to the invention the data acquisition and processing unit is set up to determine, before the beginning of a measuring period for the measuring apparatus or at the beginning of the measuring period, a weight measurement result and to monitor during the further course of the measuring period a deviation of the currently acquired measuring signals of the scale from the weight measurement result initially determined. In case the deviation exceeds a predetermined first threshold value a suspicion message indicative of a possible movement of the subject is generated to be utilized in an assessment of the reliability of the measurement result for the further body parameter.

According to the invention the combination measuring device is arranged to utilize the data acquisition and processing unit to make use of the measuring signals of the at least one load cell of the scale even after determination of the weight measurement result, in order to thereby detect possible movements of the subject during the further course of the measuring period of the measuring apparatus for measuring the further body parameter to include such information in the evaluation of the reliability of the measurement of the further body parameter.

In principle, also conventional combination measuring devices including a scale can be retrofitted by a software or firmware update so that they can perform the functions of the combination measuring device according to the invention utilizing the data acquisition and processing unit.

In a preferred embodiment the data acquisition and processing device is adapted to check the measurement results of the measuring apparatus over the measuring period for predetermined consistency criteria. Such consistency check is for example described for bioimpedance measurements in WO 2014/117758 A1. If a violation of a consistency criterion is found combined with the presence of a motion suspicion message, the measurement of the measuring apparatus is rejected as faulty and an output is generated which is indicative of the suspicion message regarding movement of the subject. In this manner the subject is notified that an error occurred in the measurement of the further body parameter, wherein the additional output of a movement indication informs the subject on the probable cause of the erroneous measurement so that the subject is encouraged to concentrate on avoiding movements during the next measuring period.

In a preferred embodiment an acceleration sensor is connected to the platform and the data acquisition and processing unit is arranged to generate a suspicion message indicative for a possible movement of the subject if the signal of the acceleration sensor exceeds a first acceleration threshold value.

In a preferred embodiment the data acquisition and processing unit is arranged to generate an error message indicative of a movement of the subject in case during the measuring period the deviation of the measuring signals of the scale from the weight measurement result exceeds a predetermined second threshold value which is higher than the first threshold value. If the higher second threshold value is exceeded it can be concluded with high probability that the subject has carried out a movement which interfered with the measurement of the measuring apparatus.

Alternatively or in addition the data acquisition and processing unit is arranged to generate an error message indicative for movement of the subject in case the signals of the acceleration sensor exceed a predetermined second acceleration threshold value which is higher than the first acceleration threshold value.

In a preferred embodiment the data acquisition and processing unit is adapted, if a movement error message is present, to terminate the measurement period of the measuring apparatus, and to generate an output indicative of the motion error message. If a motion error message is present, it can, as mentioned, be assumed with high probability that movement of the subject took place which corrupted the measurement. In this case the measurement can be terminated immediately, and the subject can be informed on the movement error.

In this case the data acquisition and processing unit may be further arranged, when a motion error message is present and an output indicative for the motion error has been generated, to start a new measurement period for the measuring apparatus for measuring further body parameter.

In a preferred embodiment a plurality of load cells are provided below the platform. The data acquisition and processing unit is adapted to initially acquire, in addition to the sum of the measuring signals of the load cells, for each load cell separately a load cell weight measurement result and to monitor over the measurement period for each load cell a deviation of the measuring signals from the respective load cell weight measurement result, and to generate an error message indicative of a movement of the subject if the monitoring of the deviation shows that a predetermined threshold value for a single load cell is exceeded. There are movement types, for example shifting of weight, which do not affect the sum of the load cell weight measurement results (the overall weight measurement result remains constant during a shifting of weight), so that the separate monitoring of the individual load cells increases the sensitivity for detecting movements.

In an embodiment including a plurality of load cells the data acquisition and processing unit is preferably further arranged to form the differences between the load cell weight measurement results of the individual load cells and to generate a suspicion message for incorrect positioning indicative for an incorrect positioning of the subject if any difference exceeds a predetermined difference threshold value. This can for example be the case if the subject is standing at an angle on the platform of the scale or is standing laterally shifted to one side of the platform in an unbalanced manner. As a consequence of such incorrect positioning also the measurement of the measuring apparatus for the further body parameter can be affected by the incorrect positioning. Such an incorrect positioning suspicion message can be taken into account in the evaluation of the reliability of the measurement of the measuring apparatus for the further body parameter.

For this purpose the data acquisition and processing unit may be adapted to check the measurement results of the measuring apparatus over the measurement period for predetermined consistency criteria. If a violation of a consistency criterion is detected, the measurement of the other body parameter is discarded as usual. In the present case, however, an indication of the incorrect positioning which was the probable cause of the erroneous measurement is output. As a consequence the subject is able to, before starting the next measurement period, check positioning on the scale and correct it if necessary.

### BRIEF DESCRIPTION OF THE DRAWING FIGURES

Preferred embodiments of the invention are described in detail below with regard to the attached drawing figures, wherein:

FIG. 1 is a schematic perspective view of a combination measuring device which includes a scale and a measuring apparatus for measuring the body length,

FIG. 2 is a schematic perspective view of a combination measuring device including a scale and a measuring apparatus for bioimpedance analysis,

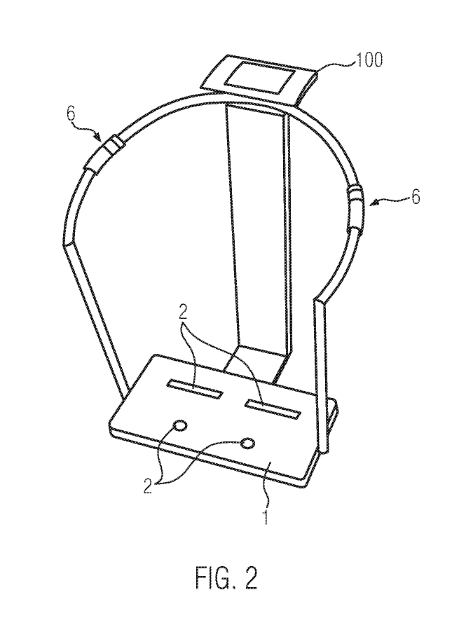

FIG. 3 shows schematic graphs of measuring signals of four load cells WZ1 to WZ4 as a function of time over a measurement period (with arbitrary units on the ordinate and abscissa of the graphs), as well as a graph of the sum of the measuring signals of the load cells, which corresponds to the total weight signal of the scale,

FIG. 4 shows graphs as in FIG. 3 for a another measurement process,

FIG. 5 shows graphs as in FIGS. 3 and 4 for a further measuring process,

FIG. 6 shows graphs as in FIGS. 3 to 5 for a further measuring process, and

FIG. 7 shows a flow diagram of a sequence control of the execution of measurements in a combination measuring device according to an embodiment of the invention.

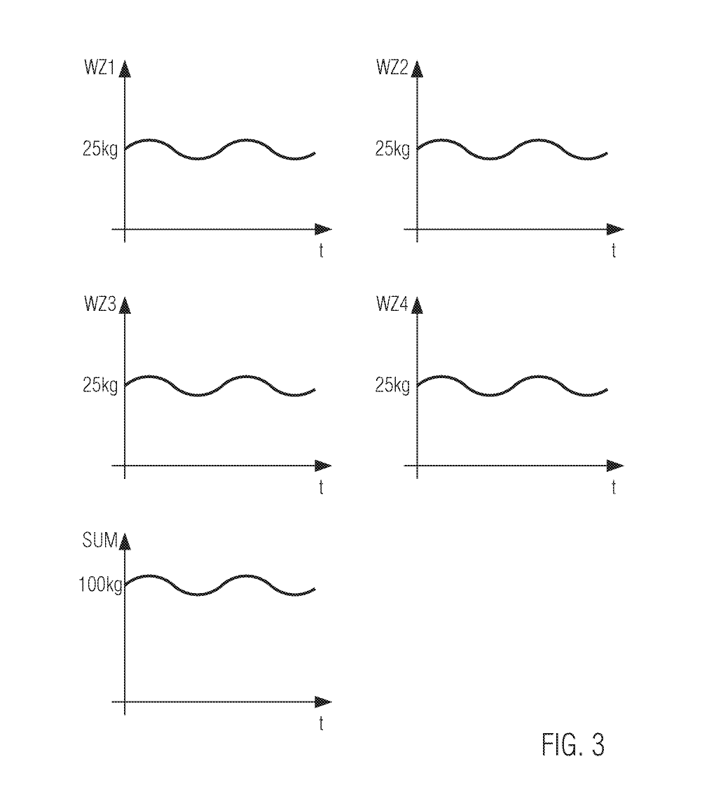

It should be noted that in FIGS. 3 to 6 the graph of the sum of the measurements signals in each case has a different scale for the Y axis compared to the other four graphs of the individual load cells.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

In the following we will first explain several measuring processes with and without movements of a subject with reference to the schematic graphs in FIGS. 3 to 6.

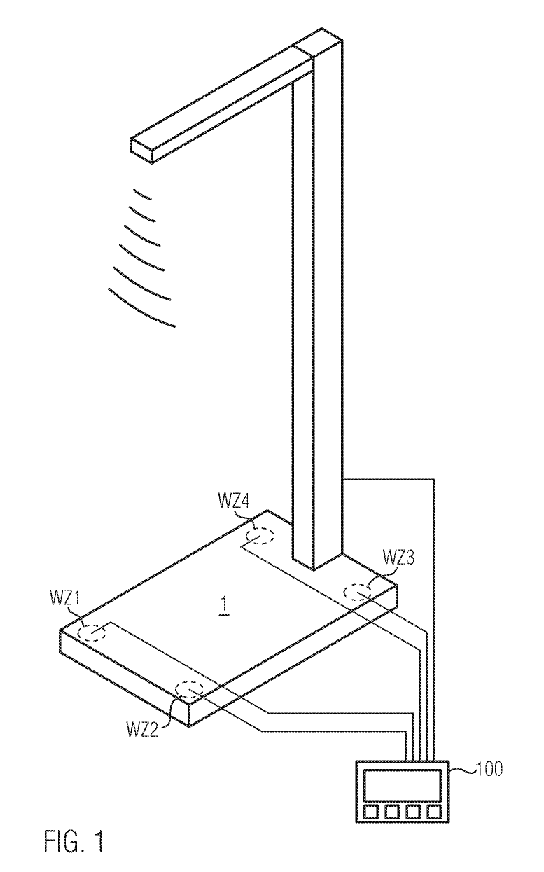

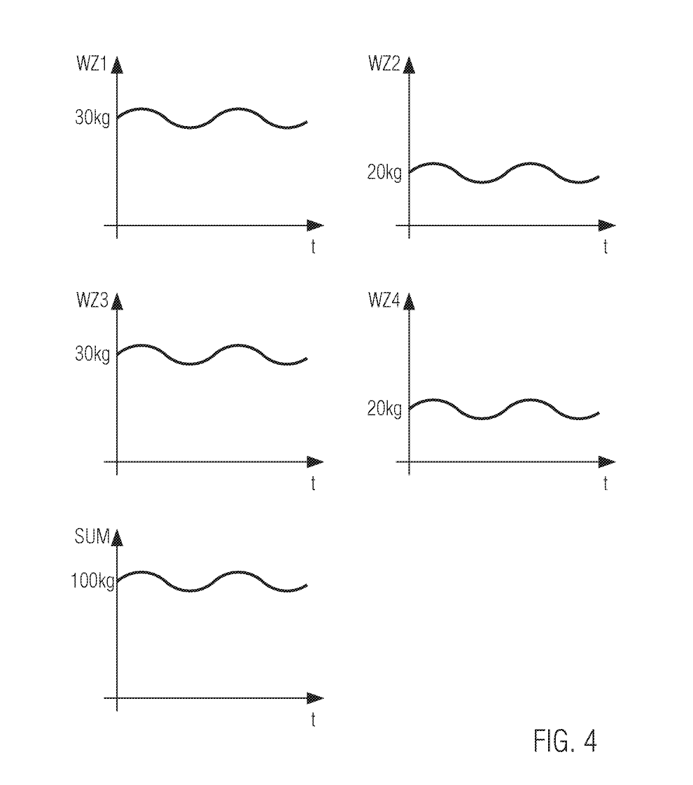

FIG. 3 shows a measuring process over a measurement period in which the measuring apparatus for measuring the further body parameter performs the measurement, wherein the subject stands steadily and centered on the platform, for example on the scale of the combination measuring device shown in FIG. 1. If the subject stands steadily and in the center on the platform of the scale as in this case, all four load cells deliver, up to minimal individual variations, the same load cell signal. The load cell signals of the load cells WZ1 to WZ4 are, as indicated, not completely constant over the time of the measuring period, but small interferences are superimposed which are caused by breathing, heartbeat and possibly other external influences. It should be noted that the graphs in FIG. 3 shows this natural fluctuations for purposes of illustration with exaggerated amplitude. This also applies to the graphs in FIGS. 4-6.

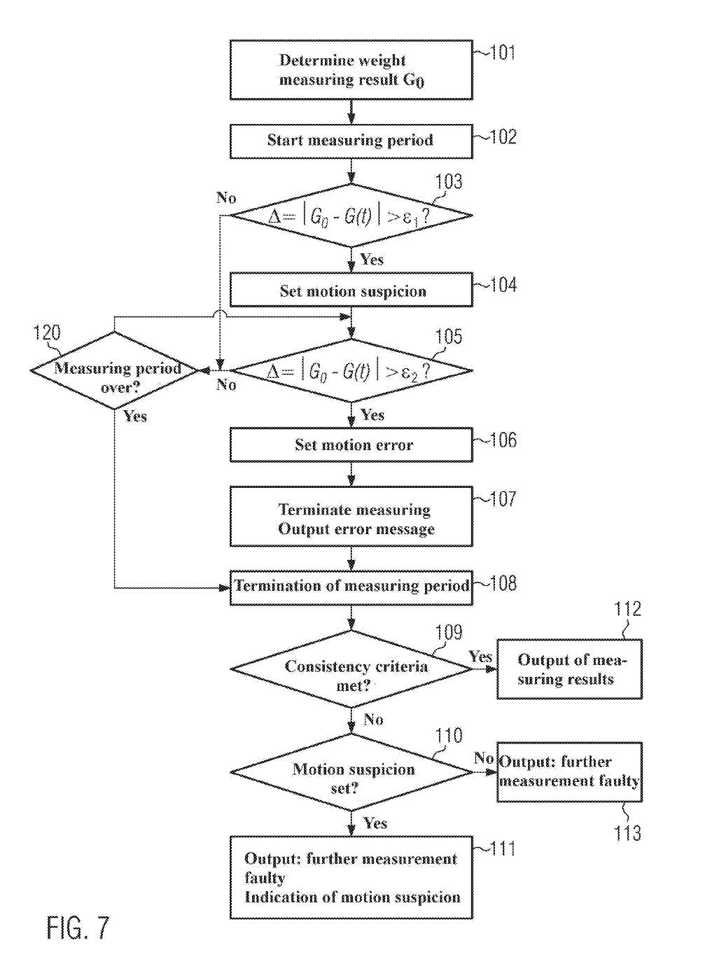

The measurement signal of each of the four load cells is converted by an analog-digital converter, and then a sum of the load cell signals corresponding to the total weight is formed. Before the start of the measurement period or at the beginning of the measurement period the total weight signal of the scale is analyzed, and a total weight measurement result is stored as soon as a hold criterion is met. This is the case when the measuring signal over a predetermined time interval is within a predetermined tolerance range around a mean value. After determination of the total weight measurement result, the absolute value of the difference between the total weight measurement result and the current total weight measuring signal of the scale is monitored over the course of the measurement period for the measurement of the further body parameter. The criteria applied during the monitoring will be described below in connection with FIG. 7.

In the measurement process shown in FIG. 3 the total weight signal of the scale which is formed as the sum of the four load cell signals, shows over the measurement period only small fluctuations which have “natural” causes such as pulse, respiration, and the like. In this case the absolute value of the difference between the total weight measurement result and the measuring signals of the scale at no point in time in the course of the measurement period exceeds the first threshold value, let alone the second threshold value. Therefore, no indicators for movement suspicion or movement error are set.

So if no indicator for movement suspicion and no indicator for movement error is set, and then in a test of consistency criteria of the measurement signals of the further measuring apparatus no criterion is found to be violated, the total weight measurement result and the measurement results of the measurement of the measuring apparatus for the further body parameter are output. However, if one of the consistency criteria is found to be violated, only the total weight measurement result and an indication that the measurement of the further body parameter is faulty, can be output, but no explanation because no indication for movement as possible cause was found.

In FIG. 4 the measurement signals of the load cells are shown for a measurement process in which the subject stands diagonally on the platform of the scale, and load cells WZ1 (front left) and WZ3 (rear right) are subject to higher weight forces than the other load cells. Although the sum of the measuring signals of the load cells which is shown in the lower graph as measuring signal of the scale is, apart from slight fluctuations, constant, and although for this reason no indicator for movement error is set, by checking differences between the measuring signals of the load cells in this case an incorrect positioning suspicion message can be generated if upon checking difference of the measuring signals of the load cells a differences threshold value is found exceeded. This incorrect positioning suspicion message can then be used, in a similar manner as a movement suspicion message, if a violation of a consistency criterion, is determined in the consistency check of the measuring signal of the measuring apparatus, and can be used for the purpose to output besides the indication that the measuring result of the measuring apparatus is faulty, an indication of incorrect positioning suspicion to provide the subject with an indication of the possible cause of the error.

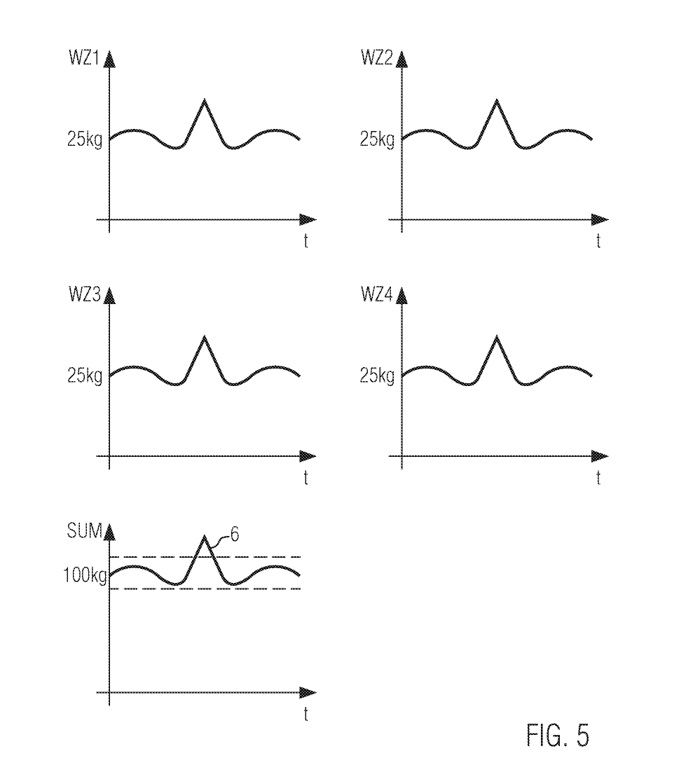

In the measuring process of the graphs in FIG. 5, after about half of the measuring period passed, a short jerky movement of the subject occurs. In the lower graph of FIG. 5 for the total weight signal of the scale an error band for the second threshold value is indicated. If the total weight signal of the scale leaves this error band, as is the case in the measuring process of FIG. 5, an indicator for a movement error is set. In this case an output is generated that the further measurement of the measuring apparatus is faulty, and in addition an indication of too much movement of the subject is output so that the subject in the next measuring period can concentrate on avoiding movements.

Such a jerky movement leads for example to a distortion of a bioimpedance measurement if the measuring apparatus for the further body parameter is a bioimpedance measuring device. In the prior art such distorted bioimpedance measurements could under certain circumstances be detected by consistency checks, but then only an output could be generated that the bioimpedance measurement is faulty, without the possibility to provide the subject with an indication that the cause of the error was excessive movement.

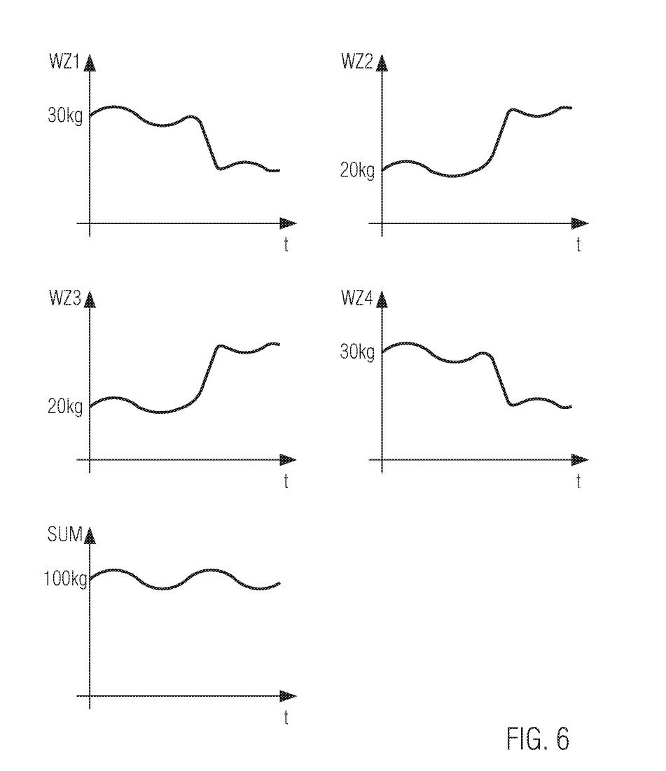

In FIG. 6 the graphs of the load cells and of the total weight measuring signal of the scale are shown for a measuring process in which the subject performs a slow, not jerky weight shift. The sum of the individual signals of the load cells in the total weight signal of the scale in the lower graph is essentially constant over the time so that on this basis no conclusion could be drawn regarding a movement. According to the present invention also the measuring signals of the individual load cells are monitored to check whether over the measuring period the difference of a load cell weight measurement result (which is determined for the individual load cell again before or at the beginning of the measuring period) and the measuring signal of the load cell in its absolute value exceeds a predetermined threshold for a single load cell in the course of the measuring period. If this is the case an error message is generated indicative of a movement of the subject. This error message is displayed together with the message that the measurement of the measuring apparatus for the further body parameter is faulty so that the subject is informed on the cause of the error and can avoid this in the next measuring period.

In FIG. 7 a flow diagram is shown illustrating the operation of the data acquisition and processing unit according to an embodiment of the combination measuring device. In this example the measuring process begins when the data acquisition and processing unit analyses the total weight signal of the scale and determines from this in advance a total weight measuring result (block 101). Thereafter, in block 102 the measuring period for the measuring apparatus is started, wherein in this flow diagram no further details for the steps of the measuring process of measuring for the further body composition parameters are shown.

After start of the measuring period it is checked in decision block 103 whether the absolute value of the difference of the total weight measuring result G₀ and the current total weight signal G(t) of the scale is larger than a first threshold value ε₁. If this is not the case, a check is made at decision block 120 whether the measuring period is to be terminated because of time out. If this is not the case, the check in decision block 103 is repeated until the time of the measurement period has expired, whereupon the process transitions from decision block 120 to the termination of the measuring period in block 108.

If it is determined during the measuring period in decision block 103 that the first threshold value has been exceeded, in block 104 an indicator for movement suspicion is set. It is then checked in decision block 105, whether the deviation of the total weight measurement result G₀ from the current measurement signals G(t) even exceeds a second, higher threshold ε₂. If this is the case an indicator of motion error is set in block 106. As a consequence the measuring period for the measuring apparatus is terminated in block 107 and a display is generated that the measurement of the measuring apparatus failed and that as a cause for the error an excessive movement of the subject has been found. Thereafter, in certain embodiments, a further measuring period is automatically started in block 102.

If in decision block 105 no exceeding of the second threshold value ε₂ is found, the process continues with decision block 120 where it is checked whether the time of the measuring period already elapsed. If so, the process continues in block 108 with the termination of the measuring period. If the measuring period is not yet completed the process returns to the entry of decision block 105.

In decision block 109 the signals acquired over the measuring period by the measuring apparatus are checked for consistency criteria. If the consistency criteria are fulfilled, the measuring results of the measuring apparatus are output in block 112. This output can of course be generated together with the output of the total weight measuring result.

If one of the consistency criteria is not fulfilled it is checked in decision block 110 whether the indicator for movement suspicion is set. If not, in block 113 only the output can be generated that the further measurement is faulty, but no output for a possible cause for this.

If the indicator for movement suspicion is set, then in block 111 in addition to an indication of the faulty measurement of the measuring apparatus an indication of the movement suspicion is output.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and access the reasonably fair scope of the present invention as pertains to any apparatus not materially departing from but outside the literal scope of the invention set forth in the following claims.

What is claimed is:

1. Combination measuring device for measuring a weight and a further body parameter of a subject, said combination measuring device comprising:
a weighing scale including a platform which acts on at least one load cell;
a measuring apparatus for measuring the further body parameter; and
a data acquisition and processing unit which is adapted to control a measuring process of the weighing scale and of the measuring apparatus,
said data acquisition and processing unit being arranged to acquire from the weighing scale measuring signals representing a weight weighing on the platform as a function of time over a measuring period, to process said measuring signals, and to output measurement results,
wherein the data acquisition and processing unit is arranged to determine a weight measuring result from the measuring signals of the weighing scale in advance or at the beginning of the measuring period, and to monitor over the measuring period a deviation of the measuring signals of the weighing scale from the weight measuring result and, in case the deviation exceeds a predetermined first threshold value, to generate a movement suspicion message indicative of a possible movement of the subject, which movement suspicion message is to be used in an examination of the reliability of the measuring result for the further body parameter.

2. Combination measuring device according to claim 1,
wherein an acceleration sensor is connected to the platform, and
wherein the data acquisition and processing unit is arranged to generate the movement suspicion message indicative of a possible movement of the subject if a signal of the acceleration sensor exceeds a first acceleration threshold value.

3. Combination measuring device according to claim 1,
wherein the data acquisition and processing unit is arranged to check a plurality of measuring results of the measuring apparatus over the measuring period for predetermined consistency criteria, and, in case a consistency criterion is found to be violated and a movement suspicion message is present, to discard the measuring results of the measuring apparatus as faulty and to generate an output indicative of the movement suspicion message.

4. Combination measuring device according to claim 1,
wherein the data acquisition and processing unit is arranged, if a deviation of the measuring signals of the weighing scale from the weight measurement result exceeds a predetermined second threshold value which is higher than the first threshold value, to generate a movement error message indicative of movement of the subject.

5. Combination measuring device according to claim 2,
wherein the data acquisition and processing unit is arranged to, if another signal of the acceleration sensor exceeds a second predetermined acceleration threshold value which is higher than the first acceleration threshold value, generate a movement error message indicative of a movement of the subject.

6. Combination measuring device according to claim 4,
wherein the data acquisition and processing unit is arranged to, in case a movement error message is present, terminate the measuring period of the measuring apparatus and generate an output indicative of the movement error message.

7. Combination measuring device according to claim 4,
wherein the data acquisition and processing unit is arranged to, if a movement error message is present and an output indicative thereof has been generated, start a new measuring period for the measuring apparatus for measuring the further body parameter.

8. Combination measuring device according to claim 1,
wherein a plurality of load cells are provided, with each of said load cells providing individual load cell measuring signals, and
wherein the data acquisition and processing unit is arranged to acquire, in addition to a sum of the measuring signals of the load cells, for each load cell individually a load cell weight measurement result, and to monitor over the measuring period for each load cell a deviation of the individual load cell measuring signal from the load cell weight measurement result and to generate, if the deviation exceeds a predetermined threshold for a single load cell, a movement error message indicative of movement of the subject.

9. Combination measuring device according to claim 8,
wherein the data acquisition and processing unit is arranged to form differences between the load cell weight measurement results and the measuring signals of the individual load cells, and, if one of said differences exceeds a predetermined difference threshold value, to generate an incorrect positioning suspicion message indicative of an incorrect positioning of the subject, which incorrect positioning suspicion message is to be used in an examination of the reliability of the measuring result for the further body parameter.

10. Combination measuring device according to claim 9,
wherein the data acquisition and processing unit is arranged to check a plurality of measuring results of the measuring apparatus over the measuring period for predetermined consistency criteria, and, if a consistency criterion is found violated and an incorrect positioning suspicion message is present, to discard the measuring results of the measuring apparatus, to generate an output indicative of the faulty measurement, and to generate an output indicative of the incorrect positioning suspicion message.

11. Combination measuring device according to claim 2,
wherein the data acquisition and processing unit is arranged to check a plurality of measuring results of the measuring apparatus over the measuring period for predetermined consistency criteria, and, in case a consistency criterion is found to be violated and a movement suspicion message is present, to discard the measuring results of the measuring apparatus as faulty and to generate an output indicative of the movement suspicion message.

12. Combination measuring device according to claim 5,
wherein the data acquisition and processing unit is arranged to, in case a movement error message is present, terminate the measuring period of the measuring apparatus and to generate an output indicative of the movement error message.

13. Combination measuring device according to claim 5,
wherein the data acquisition and processing unit is arranged to, if a movement error message is present and an output indicative thereof has been generated, start a new measuring period for the measuring apparatus for measuring the further body parameter.

14. Combination measuring device according to claim 1,
wherein said measuring apparatus comprises a device for determining a body composition parameter of the subject.

15. Combination measuring device according to claim 14,
wherein said device for determining a body composition parameter comprises a bioelectrical impedance measuring apparatus.

16. Combination measuring device according to claim 1,
wherein said measuring apparatus comprises an apparatus for measuring a body length of the subject.

17. Combination measuring device according to claim 16,
wherein said apparatus for measuring a body length comprises an ultrasonic transducer.
